(19) United States
(12) Patent Application Publication
(10) Pub. No.: US 2009/0181172 A1
(43) Pub. Date: Jul. 16, 2009

(54) LITHOGRAPHY OF NANOPARTICLE BASED INKS

(75) Inventors: Mohamed PARPIA, Toronto (CA); Emma Tevaarwerk, Evanston, IL (US); Nabil Amro, Wheeling, IL (US); Raymond Sanedrin, Skokie, IL (US)

Correspondence Address: FOLEY AND LARDNER LLP;SUITE 500, 3000 K STREET NW, WASHINGTON, DC, 20007, US

(73) Assignee: NANOINK, INC.

(21) Appl. No.: 12/251,415

(22) Filed: Oct. 14, 2008

Related U.S. Application Data
(60) Provisional application No. 60/980,141, filed on Oct. 15, 2007.

(51) Int. Cl. B05D 5/06; C09D 11/00; B05D 3/00; B05D 3/02; B22F 7/04

(52) U.S. Cl. 427/256; 106/31.13; 427/331; 427/372.2; 419/9

(57) ABSTRACT

An ink composition comprising: a plurality of metallic nanoparticles suspended in a carrier, wherein the carrier comprises water and at least one organic solvent miscible with water, and wherein the composition is formulated for slow dry rate and proper viscosity for DPN. Also, a method comprising: depositing a composition onto a cantilever, wherein the composition comprises a plurality of metallic nanoparticles suspended in a carrier, wherein the carrier comprises water and at least one organic solvent miscible with water. The composition can be used in direct writing onto surfaces to form patterns and arrays using cantilevers, microcontact printing, ink jet printing, and other methods. The composition is particularly useful for preparing nanoscale features and forming high quality continuous conductive lines and dots, including silver based lines and dots. Applications include surface repair.

### RELATED APPLICATION

This application claims priority to U.S. provisional Ser. No. 60/980,141 filed Oct. 15, 2007, which is hereby incorporated by reference in its entirety.

### BACKGROUND

Microfabrication and nanofabrication of electrical and mechanical structures at the micron and submicron scale is an important area of small scale technology including nanotechnology and nanoscale electronics. For example, nanoscale electromechanical systems desires that deposition of nanoparticles occurs in extremely narrow boundaries such as on minimally treated surfaces and that the deposition results in features with controllable dimensions that are both continuous and conductive. An important aspect of this is direct-write methods such as ink jet printing where a pattern is directly formed on a substrate. See for example Direct-Write Technologies for Rapid Prototyping Applications, Sensors, Electronics, and Integrated Power Sources, (Ed. Pique, Chrisey), 2002. However, ink jet printing can be limited in a number of respects such as nozzle clogging, for uniformity in deposited materials, and narrow ink viscosity ranges. This method can be also severely limited when smaller feature size is desired. Heated substrates can solve some problems but limit applications.

Another example of direct writing is DPN® printing (NanoInk, Chicago, Ill.), which is an additive technique that allows highly efficient, direct-write fabrication of a wide variety of materials. See for example Ginger et al., Angew. Chem. Int. Ed. 2004, 43, 30-45; Salaita et al., Nature Nanotechnology 2, 145-155 (2007). Using this and other methods, nanolithography users can build at resolutions ranging from many micrometers down to 15 nanometers, using a variety of ink materials. See for example U.S. Pat. Nos. 6,827,979 to Mirkin et al., 6,642,179 to Liu et al., and 7,081,624 to Liu et al. Scanning probe technology provides one foundation for the hardware platform of nanolithography writing systems including DPN printing. In using a scanning probe instrument for lithography, a molecule-coated probe tip which becomes a pen can be used to deposit “ink” material onto a surface. See for example U.S. Pat. Nos. 7,034,854 to Cruchon-Dupeyrat et al. and 7,005,378 to Crocker et al. See also for example US Patent Publication 2005/0235869 to Cruchon-Dupeyrat.

Deposition of metal nanoparticles with micron and nanoscale precision is needed for a variety of micro and nanoscale electronics applications. However, a need exists to provide, for example, smaller structures, more uniform structures, more continuous structures, and better reproducibility. For example, the coffee-ring effect can be troublesome in some cases where a concentration of nanoparticles is found on the outside of the deposited feature. In addition, some inks can be troublesome in attempts to pattern at the nanoscale, even if the inks are suitable for patterning at the microscale. It would be useful to be able to pattern commercially available nanoparticle inks and pastes.

### SUMMARY

Provided herein are compositions, methods of making and using the compositions, and devices and articles prepared from same.

One embodiment provides a composition comprising: a plurality of metallic nanoparticles suspended in a carrier, wherein the carrier comprises water and at least one organic solvent miscible with water.

Another embodiment provides a composition comprising: a plurality of metallic nanoparticles suspended in a carrier, wherein the carrier comprises water and at least one organic solvent miscible with water, and wherein the composition is formulated for slow dry rate and proper viscosity for DPN.

Another embodiment provides a method comprising: depositing a composition onto a cantilever, wherein the composition comprises a plurality of metallic nanoparticles suspended in a carrier, wherein the carrier comprises water and at least one organic solvent miscible with water.

Another embodiment provides a method comprising: direct writing onto a substrate surface a composition which comprises a plurality of metallic nanoparticles suspended in a carrier, wherein the carrier comprises water and at least one organic solvent miscible with water.

Another embodiment provides a method comprising: depositing a composition onto a stamp for microcontact printing, wherein the composition comprises a plurality of metallic nanoparticles suspended in a carrier, wherein the carrier comprises water and at least one organic solvent miscible with water.

Another embodiment provides a method comprising: ink jet printing a composition which comprises a plurality of metallic nanoparticles suspended in a carrier, wherein the carrier comprises water and at least one organic solvent miscible with water.

One embodiment further provides an ink composition comprising a terpene alcohol.

Another embodiment provides a method comprising: coating a cantilever with a composition comprising metallic nanoparticles and solvent carrier system, wherein the solvent carrier system comprises at least one terpene alcohol.

One or more advantages can be gained from one or more embodiments described herein. For example, at least one advantage is ability to deposit and form smaller structures. An ink can be reformulated to produce smaller feature sizes. Also, at least one additional advantage is better height uniformity and better avoidance of a coffee-ring structure. At least one additional advantage is better ink stability and long shelf life. At least one additional advantage can be better continuity, particularly for conductive structures. In addition, commercially available nanoparticle compositions can be used. At least one additional advantage can be better reproducibility. In addition, conductive lines can be prepared.

### BRIEF DESCRIPTION OF FIGURES

FIG. 1 provides an AC mode AFM image of silver features obtained by deposition of 10 wt % Ag in a commercial nanoparticle ink in tetradecane diluted 7:2:1 heptadecane:α-terpineol:octanol at 20.8° C. and 49.6% humidity using a A-frame cantilever with spring constant 0.1 N/m.

FIG. 2 provides an AC mode image of SiO₂ surface showing 300 nm features spaced by 5 μm obtained by depositing 20 wt % Ag in a commercial nanoparticle ink in water diluted by glycerol. Deposition was performed at 23.8° C. and 31.2% relative humidity using a diving-board cantilever with a spring constant 0.5 N/m.

FIG. 3 provides an AC mode AFM image showing a continuous Ag line obtained by spotting the water-glycerol-based ink as in FIG. 2 with a 200 nm pitch. The line is 800 nm wide and 5 nm tall. Deposition was performed at 22.5° C. and 50.2% humidity using an A-frame cantilever with spring constant 0.5 N/m.

FIG. 4 provides an image and table showing the dependence of feature size on amount of water-glycerol-based ink deposited. The first spot on the left has the highest volume of ink deposited, and is therefore the widest and tallest feature. The third spot on right has least amount of deposited ink. Deposition was performed at 23.3° C. and 50.9% humidity using a diving-board tip with spring constant 0.5 N/m.

FIGS. 5A, 5B, and 5C provide optical images of (A) a universal inkwell, (B) cantilever dipping into Inkwell, and (C) good ink spreading and loading on a A-frame cantilever (spring constant 0.1 N/m), respectively. The ink comprises wt. % Ag in 7:2:1 heptadecane:alpha-terpineol:octanol ink.

FIG. 6A provides an Optical microscopy image of bleeding excess silver nanoparticle (AgNP) ink with both cantilever and tip of a contact mode tip; 6B shows an AFM topography scanning image of tip bleeding dots; and 6C shows the cross-sectional topography trace of a line (marked by the dot line in 6B through the three dots.

FIGS. 7A-7B provide a schematic representation of the procedure used to direct-print AgNP inks on a SiO₂ substrate, including (i) inking the tip and (ii) depositing the ink.

FIG. 8 provides a table of comparison of the results for three different AgNP ink systems used in one experiment.

FIG. 9(i) provides an AFM topography image of silver dots generated via increasing tip-substrate contact times (A-F in FIG. 9(i)). The identification letter, time of ink printing, and measured diameter of the dots are as follows: A: 0.1 s, 1.972 μm; B: 0.2 s, 2.828 μm; C: 0.5 s, 3.87 μm; D: 1 s, 4.466 μm; E: 2 s, 4.947 μm; F: 5 s, 5.603 μm; 9(ii) shows the cross-sectional topography trace of a line (marked by the dot line in (i)) through the three dots. 9(iii) shows curves of the average silver dot diameter plotted as a function of dwell time for an AgNP and MHA inks.

FIG. 10A shows an AFM topography image of five silver lines generated via a scan rate of 10μ/s and 10B shows the cross-sectional topography trace of a line (marked by the white line in (a)) through the five lines.

FIGS. 11A-11E provide characterization of some silver lines generated. 11A provides an optical image showing continuous silver lines; 11B-11C show a silver line SEM images under different magnifications; 11D provides results of conductivity measurements after different annealing temperatures; and 11E provides the results of conductivity measurement after annealing at 200° C.

### DETAILED DESCRIPTION

### Introduction

All references cited herein are hereby incorporated by reference in their entirety.

For deposition and direct write lithography processes, including use of AFM probe to deposit structures on solid surfaces, see for example Ginger et al., Angew. Chem. Int. Ed. 2004, 43, 30-45. See also, Salaita et al., Nature Nanotechnology 2, 145-155 (2007).

Direct write processes are described in for example Direct-Write Technologies for Rapid Prototyping Applications, Sensors, Electronics, and Integrated Power Sources, (Ed. Pique, Chrisey), 2002, including Chapter 7 (ink jet methods), Chapter 8 (micropen methods), Chapter 9 (thermal spraying), Chapter 10 (Dip-Pen Nanolithography), Chapter 11 (Electron beam), and the like. Chapter 18 describes pattern and material transfer methods.

U.S. Pat. Nos. 6,635,311; 6,827,979; 7,102,656; 7,223,438; and 7,273,636 to Mirkin et al. describe various materials and methods which can be used as needed in practicing the embodiments described herein.

US Patent Publication No. 2005/0235869 to Cruchon-Dupeyrat describes more materials and methods which can be used as needed in practicing the embodiments described herein, including measuring the resistivity of metallic lines.

### Ink Composition

Ink compositions can be formulated for use in loading onto a deposition instrument, and for subsequent use in the deposition instrument in deposition onto a substrate surface. For example, viscosity and stability can be formulated. The composition can comprise metallic nanoparticles and a carrier system. The composition can be non-reactive at 25° C. and atmospheric pressure in air. In particular, the composition can be sol-gel non-reactive at 25° C. and atmospheric pressure in air. Sol gel compositions are known in the art. See for example Sol-Gel Science, The Physics and Chemistry of Sol-Gel Processing, Brinker, Scherer, 1990. The composition can comprise one or more additional components such as additives such as for example stabilizers and surfactants.

The ink can be a water based ink or an organic based ink. For example, the ink can comprise water, an organic solvent, a plurality of nanoparticles and combinations thereof. Other writeable inks can be used, including those comprising for example alkanethiols, sol-gel, antibody/antigen, lipid, deoxyribonucleic acid (DNA), block copolymer, and inorganic nanoparticles.

### Nanoparticles

Nanoparticles and metallic nanoparticles are generally known in the art. For example, nanoparticles are described in US Patent Publication No. 2005/0235869 to Cruchon-Dupeyrat, and references cited therein. Nanoparticles can have an average diameter of for example about 1,000 nm or less, or about 500 nm or less, or about 250 nm or less, or about 100 nm or less. The minimum average diameter can be for example about 1 nm, or about 3 nm. The nanoparticles can be of a size that their melting point is reduced compared to a corresponding bulk material. Nanoparticles can have for example an average particle size of 1 nm to 25 nm, or about 1 nm to about 10 nm. The size can be sufficiently small so that melting point is reduced to allow lower temperature sintering of particles into a coherent film. In many cases, the goal is to provide a nanoparticle system which will enable production of a high electronic conductivity material on a substrate.

Nanoparticles can be metallic nanoparticles including for example transition metal particles such as for example titanium, tantalum, niobium, iron, copper, ruthenium, molybdenum, nickel, cobalt, platinum, palladium, gold, or silver nanoparticles, or combinations of these metals or their alloys. In particular, conductive materials such as copper, gold, and silver can be used. The metal can be in a zero valent state. It can form conductive materials upon consolidation of individual nanoparticles into a coherent film.

Nanoparticles can have a uniform structure. For example, the nanoparticle can contain one material or element in the particle. Nanoparticles can have a core shell structure. The nanoparticle can contain one material or element in the core and one material or element in the shell. The nanoparticles can be capped nanoparticles or uncapped nanoparticles. The nanoparticles can be charged or neutral nanoparticles.

Nanoparticles can have an average particle size of, for example, about 1 nm to about 100 nm, or about 1 nm to about 50 nm, or about 5 nm to about 50 nm, or about 3 nm to about 25 nm. The particle size distribution can be polydisperse or substantially monodisperse.

Nanoparticles can comprise metal alloys.

Nanoparticles can be nanocrystals. See for example, The Chemistry of Nanostructured Materials, (Ed. P. Yang), including the chapter on nanocrystals, pages 127-146. Nanoparticles are also described in Watanabe et al., Thin Solid Films, 435, 1-2, Jul. 1, 2003 (pages 27-32).

The nanoparticles can be adapted to provide stability using for example stabilizers and surfactants.

The nanoparticles can be magnetic nanoparticles.

Nanoparticles can be obtained from commercial suppliers. See for example Harima Chemicals (Tokyo, Japan) including NP series, and PChem Associates (Bensalem, Pa.) including a PF1200 product and a PFi-201 Silver Flexographic ink.

### Aqueous-Based Carrier Solvent System

The aqueous based carrier system can be adapted for direct writing including direct writing with use of a cantilever, with a scanning probe microscope tip, and/or an atomic force microscope tip. The tip can be hollow or non-hollow.

The carrier system or solvent system can comprise water, at least one organic solvent miscible in water, or a combination thereof. In one embodiment, the carrier system comprises water and at least one organic solvent immiscible in water. The organic solvent can be a liquid at 25° C. and atmospheric pressure. The organic solvent miscible in water can be a polar solvent including for example an oxygen-containing solvent.

The carrier system or solvent system can comprise at least one solvent, or at least two solvents, or at least three solvents.

Examples of organic solvent include glycerol, ethylene glycol, poly(ethylene glycol), Tween 20 (polysorbate surfactant), and the like. The organic solvent can be for example a polyol such as for example a compound comprising at least two, or at least three hydroxyl groups such as for example, glycerol.

The organic solvent can have a molecular weight of about 300 g/mol or less, or about 200 g/mol or less, or about 100 g/mol or less.

The organic solvent can have a boiling point at 760 mm Hg, for example, of about 200° C. to about 350° C., or about 250° C. to about 300° C. The melting point can be less than about 20° C. The boiling point can be similar to glycerol which is about 290° C. at 760 mm Hg.

The organic solvent can have a viscosity at 25° C. which is greater than the viscosity of water at that temperature but less than three times, or less than two times the viscosity of glycerol at that temperature. The organic solvent can have a viscosity similar to that of glycerol. For example, the viscosity of glycerol is about 934 mPa-s at 25° C. Hence, the viscosity of the organic solvent can be for example about 2 mPa-s to about 2,000 mPa-s at 25° C., or about 100 mPa-s to about 1,500 mPa-s at 25° C.

If desired, the composition can further comprise one or more additives. For example, surfactants or dispersants can be used in the formulation to help stabilize the nanoparticles. Stabilizers or dispersants can be used.

The solvent carrier can be adapted so that viscosity is sufficient to allow the ink composition to wet a cantilever or a tip of a cantilever and provide a uniform coating thereon.

One skilled in the art can adapt the carrier system to provide the best stability or shelf life for the ink formulation.

The pH can be adapted as needed for best application.

Surfactants can be used to tune the contact angle.

The nanoparticles and the solvent system can be combined by sonication or aqua-sonication by a vortex system. Well-suspended nanoparticles in a solvent system can be relatively opaque, in contrast to a relatively transparent system with nanoparticles not well-suspended in a carrier.

### Amounts

The amounts of the components in the ink formulation can be measured by weight percentage. For example, the amount of metallic nanoparticle can be for example about 5 wt. % to about 35 wt. %, or about 10 wt. % to about 35 wt. %, or about 15 wt. % to about 25 wt. %.

The amount or concentration of the nanoparticles can be adapted to control the size of the deposit and the amount of material deposited.

The weight ratio of water to organic solvent can be for example about 4:1 to about 1:4, or about 3:1 to about 1:3, or about 2:1 to about 1:2, respectively.

The weight percentage of water can be greater than the weight percentage of organic solvent. Or, the weight percentage of organic solvent can be greater than the weight percentage of water.

One skilled in the art can adapt the amounts so that suitable viscosity can be achieved to adequate coat a cantilever with nanoparticles for subsequent deposition.

### Loading Ink for Deposition

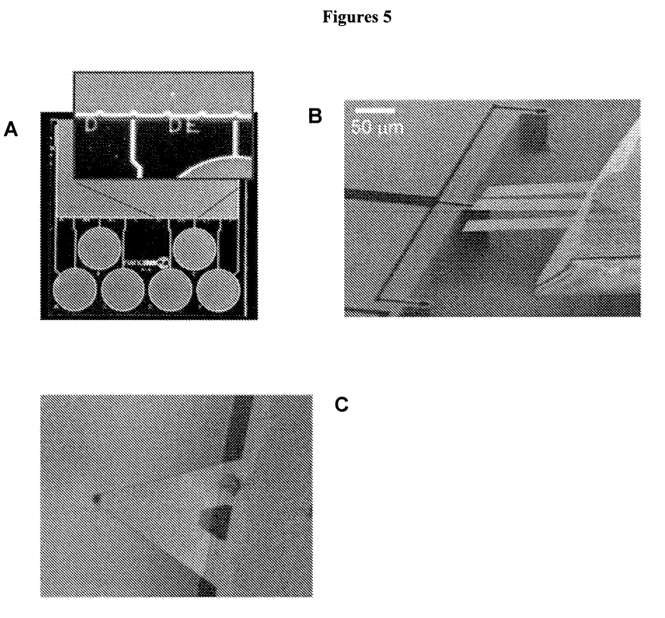

The ink composition can be subjected to an immersion step where material is transferred to for example a cantilever or a cantilever comprising a tip. For example, U.S. Pat. No. 7,034,854 describes ink delivery methods. See also commercial ink well products available from NanoInk (Skokie, Ill.) including universal inkwells (see FIGS. 5A and 5B). For example, ink can be loaded into reservoirs, and can be transferred down channels to wells which are adapted for dipping a tip or a cantilever into the well. Microfluidics can be used for ink transport. See for example Microfluidic Technology and Applications, Koch et al., 2000.

The ink composition can be used wet after transfer. Attempt to encourage drying can be avoided so that any drying which occurs is only from natural drying. In some cases, drying steps can be used but then it may be desirable to use wet conditions for transfer of the ink to the substrate (e.g., high humidity values).

The ink composition can also be transported to an end of a tip as known in the art. The hollow or open tip can be adapted to avoid clogging.

### Substrate

The substrate and substrate surface can be a variety of solid surfaces including for example semiconductor surface, conductive surface, insulating surface, metal surface, ceramic surface, glass surface, polymeric surface, and the like. The surface can be organic or inorganic. The surface can be charged or neutral. The surface can be surface modified to make it more hydrophilic (for example, piranha treatment) or more hydrophobic (for example, HF treatment).

The substrate can have a surface which is modified by an organic layer based on for example self assembled monolayers (SAMs), including surface molecules presenting different functionalities such as carboxylic acid, and also use of at least one silane, thiol, phosphate, and the like. For example, MHA modified surfaces can be used.

The substrate surface can be silicon or silicon dioxide. Substrates can comprise heat stable polymer such as, for example, polyimide.

The substrate surface can be one useful in printed electronics or the semiconductor industry.

The substrate does not need to react with or chemically bind to the metallic nanoparticles.

The temperature of the substrate surface can be varied as needed such as heated to improve deposition including for example heating on a hot plate or in an oven.

Substrates can be cleaned as needed.

### Deposition

Deposition can be carried out with for example an NSCRIPTOR instrument available from NanoInk (Skokie, Ill.). Alignment software can be used such as for example INKCAD. See also alignment in U.S. Pat. No. 7,279,046 and calibration in U.S. Pat. No. 7,060,977. Deposition can be also carried out with an SPM instrument including an AFM instrument. See also U.S. Pat. Nos. 6,635,311; 6,827,979; 7,102,656; 7,223,438; and 7,273,636 to Mirkin et al. See also US Patent Publication No. 2005/0235869 to Cruchon-Dupeyrat. Additional NanoInk patents include, for example, 7,005,378; 7,034,854; 7,098,056; 7,102,656; and 7,199,305.

NanoInk provides commercial products including for example 2D nanoprintarrays, active pens, AFM probes, bias control option, chip cracker kit, inkwells, InkCAD, vacuum pucks, and sample substrates.

Other instruments are described in for example U.S. Pat. No. 7,008,769 and US patent publication no. 2005/0266149 to Henderson et al. See also U.S. Pat. No. 6,573,369.

Scanning probe microscopy and surface modifications with same are described in, for example, Bottomley, Anal. Chem., 1998, 70, 425R-475R; and Nyffenegger et al., Chem. Rev., 97, 1195-1230.

Feedback mode can be used. No-feedback mode can be used.

In many cases, constant height mode can be used rather than constant force mode.

In some embodiments, prior to the deposition, “bleeding” can be used. Bleeding in some cases can refer to holding the cantilever and/or tip very close to the surface of the substrate and subsequently withdrawing the cantilever and/or tip from the surface to remove excess ink from the cantilever and/or tip onto the substrate.

During deposition, the cantilever can be moved over the surface or held constant over the surface.

The deposition can be carried out at temperatures of for example about 20° C. to about 35° C.

The cantilever can have a variety of spring constants which can be adapted for a particular application.

The cantilever can comprise a tip at the end. Alternatively, the cantilever can comprise no tip at the end, and can be for example a tipless cantilever. The cantilever tip can be cleaned as needed but can comprise a hard material such as silicon nitride without coating. The tip can comprise an SPM tip, an AFM tip, a nanoscopic tip, and can be solid or hollow.

Deposition can be carried out at sufficiently high humidity to encourage deposition. For example, relative humidity can be at least 30%, or at least 50%.

Deposition can be carried out on the same place multiple times to build up height. Multi-layer structures can be formed. These can comprise for example at least two, or at least three, or at least five, or at least ten layers. In some cases, the height and the lateral dimensions such as length or width can be increased by use of multiple depositions on the same spot. However, the aspect ratio of height to lateral dimension can stay substantially the same despite multiple depositions, which can be an advantage. For example, aspect ratio can be between about 10 and about 40, or between about 20 and about 30, for example. See Working Example 4 and FIG. 4. A controlled aspect ratio with multiple spotting can be indicative of a controlled system.

Parallel and massively parallel probe systems can be used for increased rates of deposition.

Thermal DPN printing can be used.

Electrostatic and thermal or piezoelectric actuation of probes and cantilevers can be used.

Treatment after Deposition

The structures disposed or deposited on the substrate can be treated with heat. Heat treatment is sometimes referred to as “annealing” or “curing.” Heat can be applied via external methods such as an oven or exposure to light beam. The heat treatment can be adapted for both time and temperature and can be adapted to provide for sintering of nanoparticles to form a continuous film and also removal of solvent carrier as well as organics as appropriate. Heat treatment can be executed at for example about 100° C. to about 1,000° C., or about 200° C. to about 600° C., or about 300° C. to about 500° C. In many cases, conditions will be adapted to achieve high conductivity and compatibility with substrate and other components in the system.

The curing time can be varied from for example two seconds to three hours, or two minutes to two hours.

In some cases, it is desired that the deposited droplet will shrink as it dries allowing for smaller structures.

### Deposited Structures

The structures disposed on the substrate can be continuous or discontinuous although in general the ultimate goal is to make a conductive continuous structure. For example, the structures can be lines or dots or spots.

If dots are spaced close enough to overlap, continuous structures including lines can be generated. The pitch between structures can be varied and can be for example less than about 1,000 nm, or less than about 500 nm, or less than about 200 nm. Ordered arrays can be fabricated. Pitch can be measured as edge-to-edge distance or from a center point of a structure such as a center of a circle or the middle of a line.

In one embodiment, the structures are continuous and have a substantially uniform height. For example, a dot can have a substantially uniform height, or a line can have a substantially uniform height.

The thickness or height, the length, and the width can be adapted for a particular application. In many cases, it is desirable to have at least one lateral dimension which is for example about 1,000 nm or less, or for example about 1 nm to about 5,000 nm, or about 10 nm to about 1,000 nm, or about 25 nm to about 500 nm. One embodiment has a lateral dimension of about 1,000 nm to about 5,000 nm.

The rate of the deposition or dwell time can be used to adjust size. In addition, multiple depositions can be carried out as desired on the same spot to adjust height and/or a lateral dimension.

A lateral dimension can be for example a substantially circular diameter or a line width.

The height or thickness can be, for example, about 1 nm to about 50 nm, or about 1 nm to about 10 nm, or about 3 nm to about 8 nm.

An important advantage is to build up height to a distance appropriate for the application.

### Characterization

The structures disposed on the substrate can be characterized by methods known in the art including for example scanning probe microscopy including AFM.

Electrical conductivity or resistivity can be measured by methods known in the art. Resistivity can be adapted with use of different thicknesses and widths of the conductive line.

### Other Deposition Methods

The compositions and inks described herein can be applied to surfaces by other methods including for example direct write methods, soft lithography methods, including for example microcontact printing and ink jet printing. Soft lithography and microcontact printing are described in for example Xia et al., Angew. Chem. Int. Ed. 1998, 37, 550-575. Ink jet printing and other direct write methods are described in for example Direct-Write Technologies for Rapid Prototyping Applications, Sensors, Electronics, and Integrated Power Sources, (Ed. Pique, Chrisey), 2002, including Chapter 7 (ink jet methods), Chapter 8 (micropen methods), Chapter 9 (thermal spraying), Chapter 10 (Dip-Pen Nanolithography), Chapter 11 (Electron beam), and the like. Chapter 18 describes pattern and material transfer methods.

Another deposition method is described in Kraus et al., Nature Nanotechnology, 2, 570-576 (2007). In this method, the authors developed a printing process that enables positioning of sub-100-nm particles individually with high placement accuracy. A colloidal suspension was inked directly onto printing plates, whose wetting properties and geometry ensure that the nanoparticles only fill predefined topographical features. The dry particle assembly was subsequently printed from the plate onto plain substrates through tailored adhesion. The authors demonstrated that the process can create a variety of particle arrangements including lines, arrays and bitmaps, while preserving the catalytic and optical activity of the individual nanoparticles.

### Organic-Based Carrier Solvent System

In another embodiment, the carrier solvent system can comprise a terpene alcohol such as a monoterpene alcohol such as a such as for example alpha-terpineol.

For example, a first component (A) of the solvent carrier system can be a high boiling hydrocarbon such as for example a long chain alkane like tetradecane, pentadecane, hexadecane, or heptadecane, or combinations thereof.

A second component (B) of the solvent carrier system can be a terpene alcohol such as for example a monoterpene alcohol such as alpha-terpineol.

A third component (C) of the solvent carrier system can be an alkanol such as for example a long chain alkanol such as octanol or decanol.

A mixture in wt. ratios of A, B, and C can be formulated at 7:2:1 and used to dilute a stock solution of nanoparticles.

In this embodiment, the weight percentage of metallic nanoparticles can be for example about 5 wt. % to about 20 wt. %.

### Applications

The compositions and methods described herein can be used in a variety of applications including, for example, applications cited in references cited herein including for example thin film transistor (TFT) fabrication, circuit editing, photomask repair, photonic crystals, chemical-/bio-sensors, waveguides, and generally applications which include use of a metal line or a conductive metal or an electrode.

Photomask repair applications are described in for example US Patent Publication Nos. 2004/0175631 and 2005/0255237.

Conductive lines and applications thereof are described in for example US Patent Publication No. 2005/0235869.

Other applications include MEMS and NEMS related applications.

Applications with conductive structures are also described in for example Fundamentals of Microfabrication, The Science of Miniaturization, 2^{nd} Ed., M. Jadou, 2002, including Chapter 10. Transistors are described in for example Thin-Film Transistors, (Kagan, Andry, Eds), 2003.

Conductive electrodes can be also important in solar cell applications. See for example, Organic Photovoltaics, Mechanisms, Materials, and Devices, (Eds. Sun and Sariciftci), 2005. Electrodes are also used in OLED, PLED, and SMOLED technologies.

Other applications include for example catalysts, fuel cells, food preservation, and drug delivery.

Nanoparticles can be also used in bio-oriented applications. See for example Nanobiotechnology II, More Concepts and Applications, (Ed. Mirkin and Niemeyer), 2007, and discussions of nanoparticles in chapters 3, 6, and 7 for example.

### NON-LIMITING WORKING EXAMPLES

A series of non-limiting working examples are provided to further illustrate various embodiments.

### Example 1

### Materials and Methods

Experiments were performed with NanoInk's NSCRIPTOR system, operating on vibration isolation air-table and in an environmental chamber. Chemicals used (glycerol, heptadecane, hexadecane, pentadecane, α-terpineol, octanol and decanol) were purchased from Sigma Aldrich and used without further purification. A 70 wt % silver nanopaste (5 nm particles in tetradecane) was purchased from Harima Chemicals (Japan), and stored in a refrigerator until use. A 40 wt % silver nanoparticle (15 nm particles) solution in aqueous solvents (water, surfactants, and adhesives) was purchased from PChem Associates (PFi-201 Silver Flexographic Ink). Inks with varying ratios of solvents were formulated by pippetting known amounts of liquid into a clean glass vial. A mass balance was used to accurately add silver nanoparticles until the ink had the desired weight percent.

A-type cantilevers (spring constant 0.1 N/m) and M-type cantilevers (spring constant 0.5 N/m) were O₂ plasma cleaned before use. Cantilevers with varying spring constants were coated with ink by dipping the cantilevers in microfluidic based inkwells for about 2 seconds. Ink was then deposited onto substrates when the cantilever was brought into contact with the surface, either in constant force mode or in constant height mode. The amount of time the cantilever was in contact with the surface (dwell time) was controlled by InkCAD software.

Patterning was achieved using liquid inks. Sometimes excess ink was bled off from the cantilever before patterning.

FIG. 5C illustrates good ink spreading onto the cantilever to provide a uniform film which is important for uniform patterning.

### Example 1(a)

### Organic Carrier System

One organic ink was based on 10 wt % silver nanoparticles in 7:2:1 heptadecane:α-terpineol:octanol.

The ink was produced by first diluting a highly viscous Ag nanoparticle stock solution with a diluting solution comprising a combination of solvents. The combination of solvent was varied to determine best composition of the solvents. The diluted Ag nanoparticle solution was then deposited by a cantilever onto the substrate lithographically in a spotting manner. The substrate with the deposited Ag inks were then annealed to obtain continuous features.

For the organic ink, the Ag particles 70 wt % silver nanoparticles (5 nm in diameter) in tetradecane purchased from Harima Chemicals, Japan was used. Investigations were performed to obtain a dilution solution with an appropriate solvent combination that was liquid at room temperature, spread on the cantilever uniformly, did not rapidly evaporate, and was miscible with tetradecane. Examples of these solvents were long chain alkanes (pentadecane to heptadecane), alcohols (octanol and decanol) and α-terpineol. An embodiment was developed for a 10 wt % silver nanoparticles in 7:2:1 heptadecane:α-terpineol:octanol ink for reproducible deposition of silver nanoparticles. It was found that varying the concentration of silver nanoparticles between 5 and 20 wt % did not appreciably change the properties of the ink. While different ratios of solvents were used, the 7:2:1 worked the best.

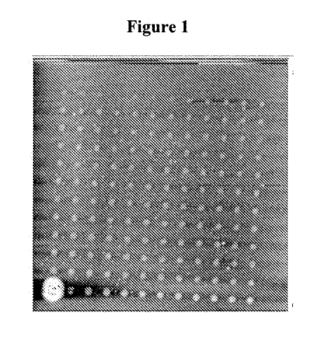

After inking the cantilever, the ink was deposited onto a silica (SiO₂) substrate in a spotting manner using a dwell time of 0.01 s per spot. About 10 such arrays were written before running out of ink on the cantilever. The substrate was then annealed on a hot plate to about 400° C. for 30 minutes. FIG. 1 shows a dot array obtained after annealing the substrate following deposition with the 10 wt % Ag in 7:2:1 heptadecane:α-terpineol:octanol ink. The features are between 1.7-2.2 μm in diameter and 4-7 nm in height. Similar features were obtained by using different solvents from the same family, such as hexadecane being substituted for heptadecane or decanol being used instead of octanol. Larger features were obtained by increasing the dwell time, thereby allowing more ink to flow from the cantilever to the substrate. Finally, continuous features were obtained, thereby substantially eliminating the “coffee ring” effects and the non-continuous features produced by ink jet printing and DPN printing because during the anneal process, the evaporating solvent carries the nanoparticles towards the center of the spot. This is in stark contrast to “coffee ring” effects, or not continuous features obtained by ink jet printing and DPN experiments.

### Example 1(b)

### Surface Hydrophilicity/Hydrophobicity

To obtain features with nanoscale diameters with this ink, the effect of surface chemistry was investigated. Two surfaces, one hydrophobic, one hydrophilic were prepared by immersing the substrates in hydrogen fluoride (HF) and piranha, respectively, for the ink to bead up on the hydrophilic surface, and to spread readily on the hydrophobic surface. Beading up of the ink can reduce the size of the footprint of the ink on the surface, resulting in smaller features. However, features obtained on the hydrophilic surface had some dimensions still in the micron regime, though they were about 26 nm tall. Thus, these results suggest that the determining factor in the size of the feature in this embodiment was controlled by the droplet of ink coming off the cantilever, and not be variations in surface chemistry, or dwell times. Therefore, to obtain features with nanoscale diameters, the size of the droplet at the end of the cantilever can be changed.

One method to accomplish this goal is to change the surface tension of the ink. Surface tension is an interfacial phenomenon that tends to minimize the exposed surface area of the liquid. Aqueous solvents have hydrogen bonding interactions between individual molecules, which are stronger than van der walls interactions present between molecules of the hydrophobic ink. Thus, although the present inventions are not limited by theory, aqueous based inks may form smaller droplets of ink as the ink is being deposited on the surface.

### Example 1(c)

### Aqueous Ink Carriers

For the aqueous ink, 15 nm silver nanoparticles (40 wt %) in aqueous surfactant were purchased from PChem Associates, Inc. In the investigation of obtaining a good combination of solvent for the dilution solution, it was found that among the solvents, such as poly (ethylene glycol), Tween 20 (polysorbate surfactant), ethylene glycol, and glycerol, except glycerol, the nanoparticles aggregated within 1 hour, whereas in glycerol they remained suspended for about 5 hours. Additionally, the nanoparticles can easily be re-suspended in glycerol by sonicating the ink for 2 minutes followed by placing the ink vial on a vortex for 30 seconds. This ink can have a very long shelf-life, and can potentially be used indefinitely. In one experiment performed to determine the hold time of the glycerol solvated Ag nanoparticle ink on the cantilever, the ink was formulated in a 1:1 ratio of the stock silver nanoparticle surfactant solution to glycerol, resulting in a 20 wt % silver nanoparticle ink. The results from optical observations showed that from a small amount (0.2 μL) of the ink, it took over 20 minutes for the ink to evaporate from the cantilever.

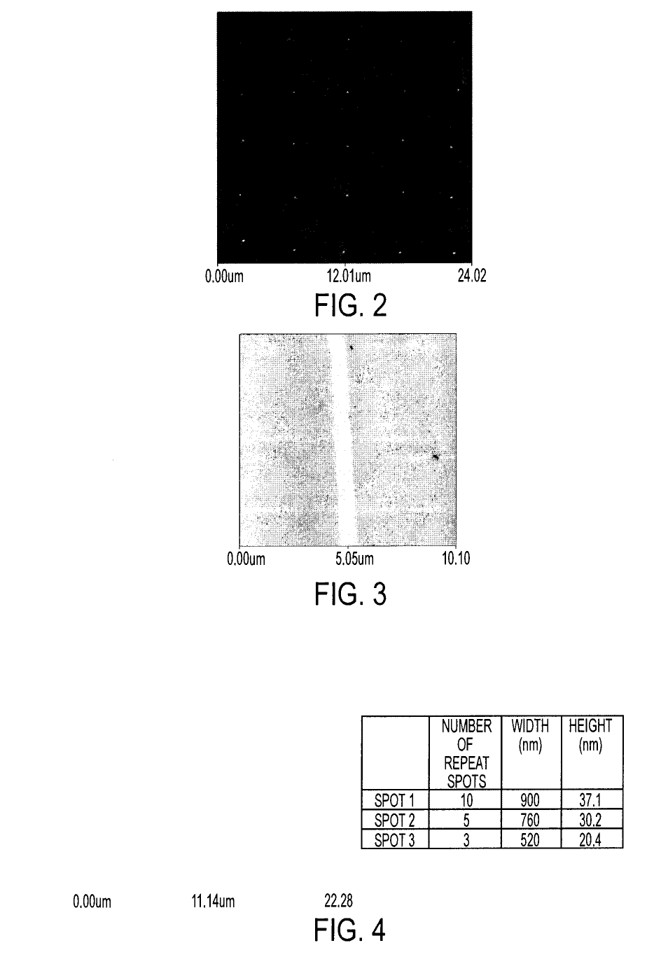

The aqueous ink (20 wt % Ag NP in 1:1 glycerol:surfactant) was spotted on a SiO₂ substrate with a dwell time of 0.01 s. FIG. 2 illustrates that after annealing the substrate at 500° C. for 30 minutes, continuous dots that were about 300 nm in diameter and about 5 nm tall were obtained. Additionally, by spotting the ink with a 200 nm pitch, continuous lines was obtained with this ink because the nanoparticles sintered together during the anneal process; see FIG. 3. Continuous features were obtained because during evaporation, the solvent formed a meniscus, which carrier the nanoparticles towards the center of the spot. Similar results were obtained by using inks that had a higher concentration of silver nanoparticles, or by using inks that are suspended in solvents similar to glycerol, or using different concentrations of glycerol.

### Example 1(d)

### Spotting in Same Location

In one embodiment, for both organic and aqueous inks, the sizes (both width and height) of the features depended on the amount of ink deposited, which in turn can be controlled by the number of times the ink was spotted in the same location. FIG. 4 demonstrate this dependence of the aqueous ink on a sample. The dwell time was 10 mS. It was observed that the deposition from 10 repetitions of spotting resulted in the widest and tallest features in the group.

For both the organic and aqueous inks, the Alignment feature of InkCAD was used to return to the previously written features for imaging after annealing.

### Example 2

In this series of experiment, Nanoink's inkwell, single pen tip, and plasma enhanced chemical vapor deposition (PECVD) SiO₂ substrate were oxygen plasma cleaned for 3 min with a moderate power at 300 torr to remove organic contamination and create a fresh surface. A hydrophilic drop-on-demand (DOD) inkjet silver nanoparticle (AgNP) ink, which was a water based ink (PFI200, PChem Associate), was used. The ink was loaded to the microfluidic channel of inkwell chip, and to load the ink on the tip and cantilever, the scanner was aligned and further lowered down such that the ink in the microchannel wetted the tips and partially the cantilever surface due to surface tension. See Bjoern et al., Smart Materials & Structures 15 (1): S124-30 (2006); Rivas-Cardona et al., Journal of Microlithography, microfabrication, and Microsystems 6(3) (2007).

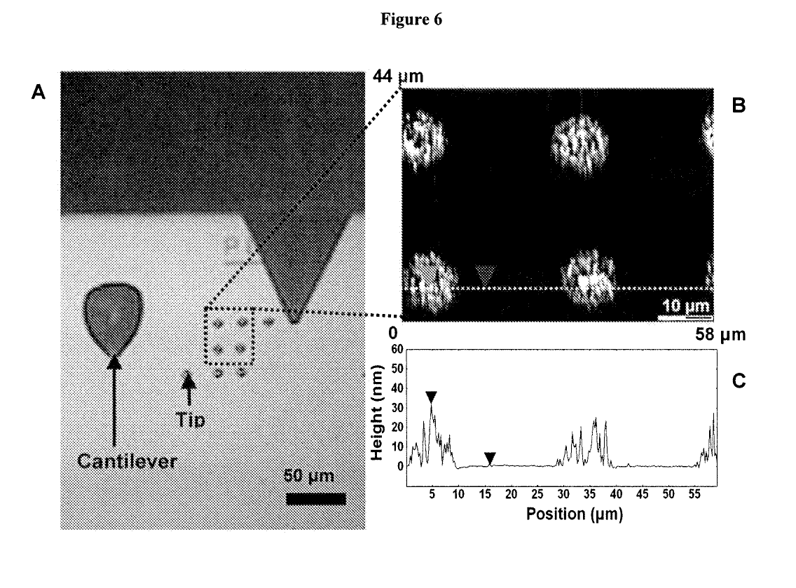

FIG. 6A shows a standard contact mode silicon nitride (SiN) tip after ink loading on triangular cantilever and the following wetting traces of excess AgNP ink, herein referred to as “bleeding,” on silicon dioxide substrate with both cantilever and tip by bringing inked tip in contact with substrate. After curing by a 200° C. hotplate for 10 min, the traces were scanned by an AFM in the AC mode with a scan rate of 1 Hz. The AFM topography image and the trace cross section through the bleeding dots are shown individually in FIGS. 6B-6C. The diameter of the tip bleeding dot was about 10 μm, with an average height of about 25 nm, which was doubly larger than the size of the tip pyramid base (5 μm). At this stage, a continuous tip bleeding was used to remove the over-rich ink such that a moderate ink coating on tip can be obtained. This can be determined optically by the reduced size of tip bleeding dot down to about 2 μm or even smaller.

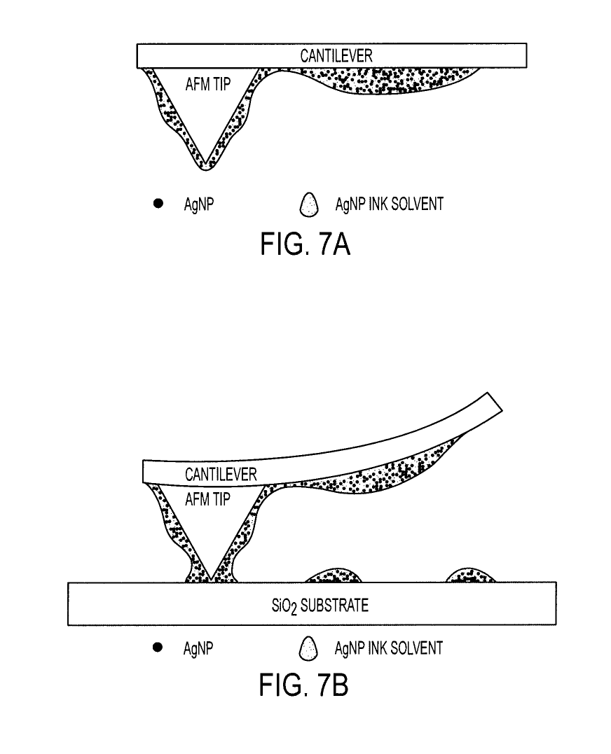

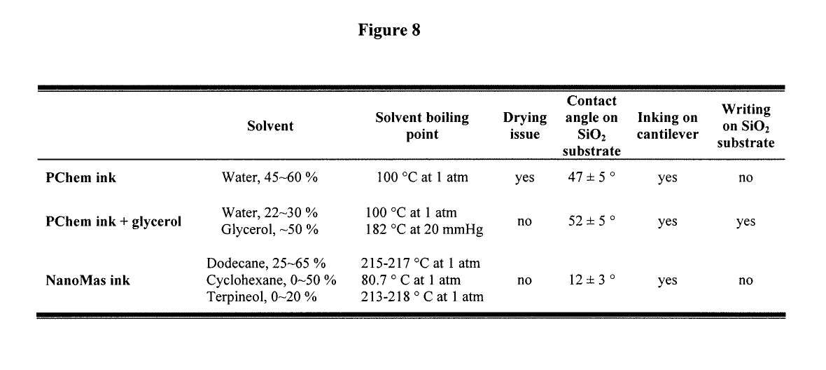

In comparison to conventional mercaptohexanoic acid (MHA) DPN process, which utilize native water meniscus in a humid environment to transport MHA, the liquid phase DPN process was carried by surface tension behavior. A schematic of liquid phase DPN process for DOD inkjet AgNP ink is illustrated in FIG. 7. A cleaned SiO₂ or SiN surface is more hydrophobic than the ink, and the hydrophilic ink can be transferred from the SiN tip to the SiO₂ substrate because the ink has low affinity to either surface.

The ability to manipulate the hydrophilicity was verified by contrasting a water-based ink as described above with an organic based ink (NST05, NanoMas Technologies, Inc.). The results show that after inking the surface of the cantilever, ink transportation from the tip to the substrate during bleeding did not occur. Additionally, the solvent dried up such that the DPN of organic AgNP did not occur. Comparisons of the DPN results of three different inks are provided in FIG. 8. A comparison of contact angle by different inks onto a oxygen cleaned substrate was also performed to simulate a writing condition.

An organic hydrophobic ink from InkTec (InkTec, Irvine, Calif.) was also tested. It was observed that the ink was very hydrophobic, and the DPN can only be performed on a hydrophobic surface, such as the Inkwell substrate surface.

Additionally, ethylene glycerol/hydrophilic based nano silver particle inks (NovaCentrix Inc., Texas) were also tested. The results show that the inks with 10% Ag and 40% Ag were direct “DPN-able,” but never the less exhibit issues with respect to fast drying, viscosity, and hydropolarity. Further, it was found that with these inks uniform dot/line writing was more difficult to obtain.

The results demonstrated a water based ink with a slow dry-rate and a proper viscosity can facilitate the DPN process.

To minimizing the problem of ink drying too fast, a solvent with a high boiling point temperature was added. In one embodiment, the solvent was hydrophilic glycerol (boiling point is 182° C. at 20 mmHg) in a AgNP ink. Note that other solvent may be added, including octanonl, dodecane, or PEG. It was observed that a drop of this modified ink in Inkwell can remain over 2 weeks. Additionally, the AgNP were stabilized and well-suspended in the solvent through a layer coating of functional surfactant; see Bao et al., J. Mater. Chem 17, p 1725 (2007). To retract the homogeneous particle suspension after adding glycerol, about 10 min of vortexing in Vortexer (Southwest Scientific), followed by 20 min of ultrasonication, was used to obtain an opaque black ink. Furthermore, the DPN process was performed under a constant height mode without aligning laser spot on the cantilever to avoid heating the cantilever and to facilitate evaporation of the solvent.

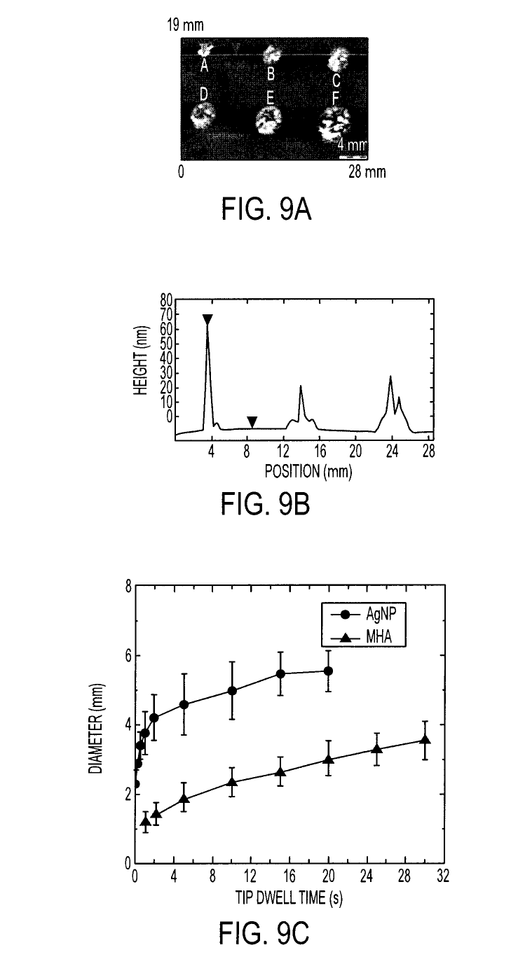

The dot calibration with different dwell times was performed and the AFM topography, cross-section, and the average silver dot diameter curves plotted as a function of dwell time are shown in FIGS. 9A-9C. A trend of increasing dot size with increasing dwell time is shown in FIGS. 9A-B. The dot calibration for AgNP was also compared with another common DPN inks, MHA, as shown in FIG. 9C. not to be bound by any particular theory, the fitted curves in FIG. 9C provides the intersection in y-axis that show the initial ink loading on the tip, and the maximum dot indicate the ink morphology between top-substrate reach an equilibrium. Further, not to be bound by any particular theory, the DPN process with MHA ink can be dominated by chemi-sorption, whereas that with AgNP ink can be dominated by physi-sorption because there is substantially no specific chemical binding between solvent and SiO₂ surface, or AgNP and SiO₂ surface. Thus, surface tension affected the feature size and the system was a physic-sorption process in this embodiment.

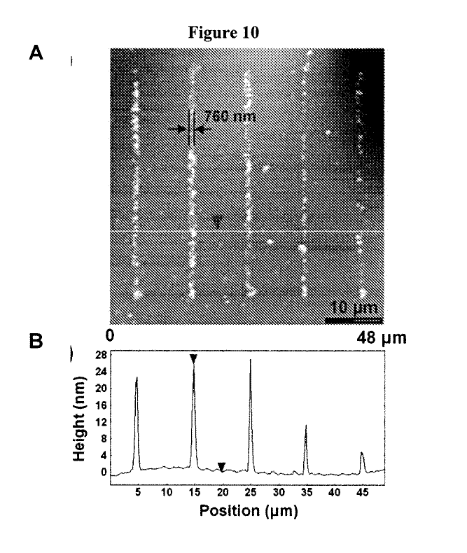

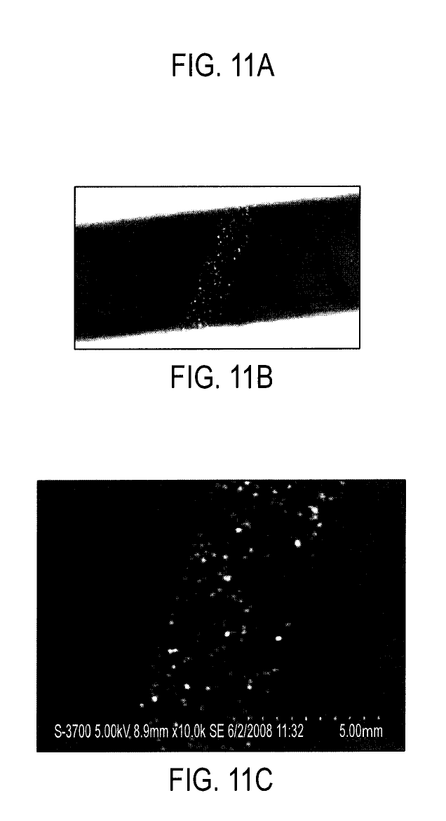

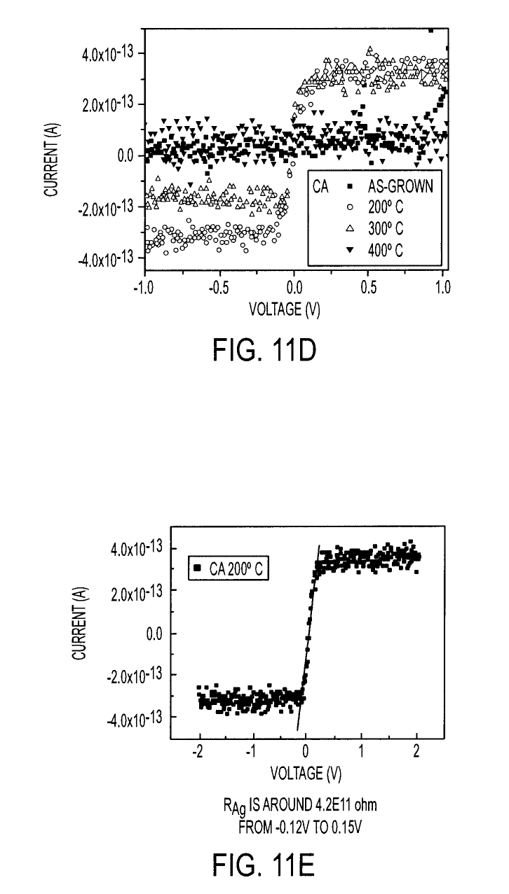

To evaluate the future applications, 40 μm lines with chosen writing speed were demonstrated. FIGS. 10A-10B show both the AFM topography and the cross-section height profile, respectively. The minimum width was about 760 nm, and for line width greater than 2 μm (see FIGS. 11A-11C), conductivity measurements were conducted; the results are shown in FIGS. 11C-D. As seen in the optical image of the lines in FIG. 11A, the lines are continuous.

The lines with contact metal as-deposited show minimal conductivity, acting similarly to an electrical insulator (see FIG. 11D). However, after the lines were annealed at 200° C., they began to exhibit conducting behavior (see FIGS. 11D-11E). Not to be bound by any particular theory, the high electrical resistance can arise from the very thin layer of AgNP (about 20-30 nm) and/or possible surface oxidation, and the conducting behavior may be attributed to the removal of the Schottky defects in the silver metal lines by annealing.

One skilled in the art can employ the following references in carrying out claimed embodiments:
1. Daniel Huang, Frank Liao, Steven Molesa, David Redinger, and Vivek Subramanian, “Plastic-Compatible Low Resistance Printable Gold Nanoparticle Conductors for Flexible Electronics,” J. Electrochem. Soc., Volume 150(7), pp. G412-G417 (2003).
2. Seamus E. Burns, Paul Cain, John Mills, Jizheng Wang, and Henning Sirringhaus, “Inkjet printing of polymer thin-film transistor circuits,” MRS bulletin 28 (11), pg: 829-834 (2003).
3. Seung H Ko, Heng Pan, Costas P. Grigoropoulos, Christine K. Luscombe, Jean M J Fréchet, and Dimos Poulikakos, “All-inkjet-printed flexible electronics fabrication on a polymer substrate by low-temperature high-resolution selective laser sintering of metal nanoparticles,” Nanotechnology 18, 345202 (2007).
4. Venugopal Santhanam and Ronald P. Andres, “Microcontact Printing of Uniform Nanoparticle Arrays,” Nano Letters 4 (1), 41-44 (2004).
5. Wei Lu and Charles M. Lieber, “Nanoelectronics from the bottom up,” Nature Mater. 6, 841-850 (2007).
6. Xinping Zhang, Baoquan Sun, Richard H. Friend, Hongcang Guo, Dietmar Nau, and Harald Giessen, “Metallic Photonic Crystals Based on Solution-Processible Gold Nanoparticles,” Nano Lett. 6 (4), 651-655 (2006).
7. Shawn Keebaugh, A. Kaan Kalkan, Wook Jun Nam, and Stephen J. Fonash, “Gold Nanowires for the Detection of Elemental and Ionic Mercury,” Electrochem. Solid-State Lett. 9 (9), H88-H91 (2006).
8. David S. Ginger, Hua Zhang, and Chad A. Mirkin, “The Evolution of Dip-Pen Nanolithography,” Angew. Chem. Int. Ed. 43, 30-45 (2004).
9. Khalid Salaita, Yuhuang Wang, and Chad. A. Mirkin, “Applications of Dip-Pen Nanolithography,” Nature Nanotechnology 2, 145-155 (2007).
10. Jason Haaheim and Omkar A. Nafday, “Dip Pen Nanolithography®: A “Desktop Nanofab™” Approach Using High-Throughput Flexible Nanopatterning,” Scanning 30, 137-150 (2008)
11. Bjoern Rosner, Terrisa Duenas, Debjyoti Banerjee, Roger Shile, Nabil Amro and Jeff Rendlenl, “Functional extensions of Dip Pen Nanolithography™: active probes and microfluidic ink delivery”, Smart Materials & Structures 15(1), :S124-S130 (2006).
12. Juan Alberto Rivas-Cardona and Debjyoti Banerjee, “Microfluidic device for delivery of multiple inks for dip pen nanolithography,” Journal of microlithography, microfabrication, and Microsystems 6(3), (2007).
13. Bao Toan Nguyen, Julien E. Gautrot, My T. Nguyen and X. X. Zhu, “Nitrocellulose-stabilized silver nanoparticles as low conversion temperature precursors useful for inkjet printed electronics,” J. Mater. Chem. 17, 1725-1730 (2007).

What is claimed:

1. A composition comprising:
a plurality of metallic nanoparticles suspended in a carrier, wherein the carrier comprises water and at least one organic solvent miscible with water, and wherein the composition is formulated for slow dry rate and proper viscosity for DPN.

2. The composition according to claim 1, wherein the metallic nanoparticles are nanoparticles of Ti, Ta, Nb, Fe, Cu, Ru, Mo, Ni, Co, Pt, Ag, Au, Pd, or combinations thereof.

3. The composition according to claim 1, wherein the metallic nanoparticles comprise silver.

4. The composition according to claim 1, wherein the nanoparticles are core-shell nanoparticles.

5. The composition according to claim 1, wherein the nanoparticles are capped nanoparticles.

6. The composition according to claim 1, wherein the nanoparticles are uncapped nanoparticles.

7. The composition according to claim 1, wherein the metallic nanoparticles have an average particle size of about 1 nm to about 100 nm.

8. The composition according to claim 1, wherein the metallic nanoparticles have an average particle size of about 3 nm to about 25 nm.

9. The composition according to claim 1, wherein the organic solvent is an oxygen-containing solvent.

10. The composition according to claim 1, wherein the organic solvent is a polyol.

11. The composition according to claim 1, wherein the organic solvent is glycerol.

12. The composition according to claim 1, wherein the wt. % of nanoparticles is about 5 wt. % to about 35 wt. %.

13. The composition according to claim 1, wherein the wt. % of nanoparticles is about 10 wt. % to about 25 wt. %.

14. The composition according to claim 1, wherein the wt. ratio of water to solvent is about 4:1 to 1:4, respectively.

15. The composition according to claim 1, wherein the wt. ratio of water to solvent is about 3:1 to 1:3, respectively.

16. The composition according to claim 1, wherein the wt. ratio of water to solvent is about 2:1 to 1:2, respectively.

17. The composition according to claim 1, wherein the wt. % of water is greater than the wt. % of solvent.

18. The composition according to claim 1, wherein the wt. % of solvent is greater than the wt. % of water.

19. The composition according to claim 1, wherein the composition is not a reactive composition at 25° C. and atmospheric pressure in air.

20. The composition according to claim 1, wherein the composition is not a sol-gel reactive composition at 25° C. and atmospheric pressure in air.

21. The composition according to claim 1, wherein the metallic nanoparticles are not metal oxide nanoparticles.

22. The composition according to claim 1, wherein the composition further comprises at least one additive.

23. The composition according to claim 1, wherein the metallic nanoparticles are silver nanoparticles and the organic solvent is glycerol, and wherein the metallic nanoparticles have an average particle size of about 3 nm to about 25 nm.

24. A method comprising:
depositing a composition onto a cantilever, wherein the composition comprises a plurality of metallic nanoparticles suspended in a carrier, wherein the carrier comprises water and at least one organic solvent miscible with water.

25. The method of claim 24, wherein the cantilever is a tipless cantilever or a cantilever which comprises a tip.

26. The method of claim 24, wherein the cantilever is a tipless cantilever or a cantilever which comprises a scanning probe microscopic tip.

27. The method of claim 24, wherein the cantilever is a tipless cantilever or a cantilever which comprises an atomic force microscope tip.

28. The method of claim 24, wherein the cantilever comprises an AFM tip, and the tip is coated with the composition.

29. The method of claim 24, further comprising the step of removing the carrier to leave a coating of nanoparticles on the cantilever.

30. The method of claim 24, further comprising the step of removing the carrier to leave a dry coating of nanoparticles on the cantilever.

31. The method of claim 24, further comprising the step of removing the carrier to leave a coating of wet nanoparticles on the cantilever.

32. The method of claim 24, further comprising the step of depositing the nanoparticles from the cantilever onto a substrate surface.

33. The method of claim 24, further comprising the step of depositing the nanoparticles from the cantilever onto a substrate surface, and further comprising the step of heating the deposited nanoparticles on the substrate surface.

34. The method of claim 24, further comprising heat treating the deposited nanoparticles on the substrate.

35. The method of claim 34, wherein the heat treated nanoparticles form at least one continuous line.

36. The method of claim 24, further comprising bleeding off excess of the composition from the cantilever prior to depositing.

37. A method comprising:
direct writing onto a substrate surface a composition which comprises a plurality of metallic nanoparticles suspended in a carrier, wherein the carrier comprises water and at least one organic solvent miscible with water.

38. A method comprising:
depositing a composition onto a stamp for microcontact printing, wherein the composition comprises a plurality of metallic nanoparticles suspended in a carrier, wherein the carrier comprises water and at least one organic solvent miscible with water.

39. A method comprising:
ink jet printing a composition which comprises a plurality of metallic nanoparticles suspended in a carrier, wherein the carrier comprises water and at least one organic solvent miscible with water.

40. A method comprising:
coating a cantilever with a composition comprising metallic nanoparticles and solvent carrier system, wherein the solvent carrier system comprises at least one terpene alcohol.

41. The method of claim 40, further comprising depositing nanoparticles from the cantilever to a substrate surface.

42. A method comprising:
combining a plurality of metallic nanoparticles with a carrier, wherein the carrier comprises water and at least one organic solvent miscible with water.

43. A method comprising:
providing a composition comprising metallic nanoparticles and an aqueous carrier, and
diluting the carrier with at least one organic solvent miscible with water to achieve a stable dispersion and allow for deposition of the composition from a nanoscopic tip to a surface.

44. A method comprising:
providing a composition comprising metallic nanoparticles and an aqueous carrier, and
diluting the carrier with at least one organic solvent miscible with water to achieve a stable dispersion and allow for uniform coating of a cantilever.

45. A composition consisting essentially of:
a plurality of metallic nanoparticles suspended in a carrier, wherein the carrier comprises water and at least one organic solvent miscible with water.

46. A method of forming a metal line, comprising:
providing a composition, wherein the composition comprises a plurality of metallic nanoparticles in a carrier, wherein the carrier comprises water and at least one organic solvent miscible with water;
depositing the composition onto a substrate;
annealing the composition on the substrate, whereby the metallic nanoparticles form the metal line.
